(19) United States
(12) Patent Application Publication
(10) Pub. No.: US 2008/0159572 A1
(43) Pub. Date: Jul. 3, 2008

(54) Multiple Loudspeaker Device

(75) Inventor: David M.E. Corynen, Eindhoven (NL)

Correspondence Address: SHEEHAN PHINNEY BASS & GREEN, PA;c/o PETER NIEVES, 1000 ELM STREET, MANCHESTER, NH, 03105-3701, US

(73) Assignee: PSS BELGIUM N.V., Eindhoven (NL)

(21) Appl. No.: 11/817,928

(22) PCT Filed: Jan. 2, 2006
(86) PCT No.: PCT/IB06/50003

§ 371 Date: Jan. 4, 2008

(30) Foreign Application Priority Data
Mar. 17, 2005 (EP) 05102091.5

(51) Int. Cl. H04R 5/02; H04R 1/26

(52) U.S. Cl. 381/308

(57) ABSTRACT

A multiple loudspeaker deviceQ) comprising a frame (3) with a first loudspeaker (5) for reproducing sound in a higher frequency range and a second loudspeaker (7) for reproducing sound in a lower frequency range, the frequency ranges having a crossover frequency fc. The first loud-speaker has a first radiation surface (5a) of maximal 1000 m2 and the second loudspeaker has a second radiation surface (7a), a central area (5b) of the first radiation surface and a central area (7b) of the second radiation surface being situated at a vertical distance d from each other. In order to obtain sound of high quality the parameters fc and d have the following values: 750 Hz<f_{c}<3000 Hz, d>2. λJfc, (λJ−c is the wavelength of the reproduced sound at fc), and 750 mm<d<3000 mm.

The invention relates to a multiple loudspeaker device comprising a frame with a first loudspeaker for reproducing sound in a higher frequency range and a second loudspeaker for reproducing sound in a lower frequency range.

It is known in the field that the ideal loudspeaker can only be approximated by a very small pulsating point source generating the full audible frequency spectrum from 20 Hz to 20 kHz without distortion or compression. Therefore, a single full-range loudspeaker always suffers from compromising on performance. For this reason arrangements of two loudspeakers, i.e. a first loudspeaker for reproducing sound in a higher frequency range and a second loudspeaker for reproducing sound in a lower frequency range are, used to reproduce high quality audio, each loudspeaker working in a specific frequency range. Pursuant to current teaching the loudspeakers in such arrangements are positioned close to each other to come close to the ideal full-range point source. However, such multiple loudspeaker devices are far from ideal and suffer from acoustic phase, level and power irregularities around the crossover frequency, resulting in blur and coloration of the reproduced sound. It is to be noted that the term “crossover frequency” means in this paper the frequency at which the electrically and/or mechanically and/or acoustically reduced sound level of the first loudspeaker and the electrically and/or mechanically and/or acoustically reduced sound level of the second loudspeaker are the same, wherein the sound pressure level of the combination of first and second loudspeaker is substantially balanced, measured at a distance of at least three meters from said combination.

An electrical filter may be used to direct appropriate frequencies to a first speaker (tweeter) or a second speaker (woofer) of a loudspeaker system and thus to reduce the sound level at other frequencies.

An object of the invention is to provide multiple loudspeaker devices, which are able to reproduce sound of an improved quality with respect to the known similar devices.

This object is achieved by the stand-alone multiple loudspeaker device according to the invention, which comprises a frame with a first loudspeaker for reproducing sound in a higher frequency range and a second loudspeaker for reproducing sound in a lower frequency range, the frequency ranges having a crossover frequency f_{c}, which first loudspeaker has a first radiation surface of maximal 1000 mm² and which second loudspeaker has a second radiation surface, a central area of the first radiation surface and a central area of the second radiation surface being situated, at least during use, at a vertical distance d from each other, wherein

750 Hz≦f_{c}≦3000 Hz, and

d≧2. λ_{fc}, wherein λ_{fc} is the wavelength of the reproduced sound at the crossover frequency and wherein d is minimal 750 mm and maximal 3000 mm.

The measures applied into the loudspeaker device according to the invention are based on a new design philosophy. This philosophy implies that there should be little or preferably no interference between the sound of the second loudspeaker and the direct sound of the first loudspeaker. In this context it is to be noted that the term “direct sound” means in this paper the sound that arrives at a certain place directly from the sound source, thus without reflection. Due to the location of the second loudspeaker at a certain minimum distance d from the first loudspeaker—as worded above—a reduced interference is obtainable. For the sake of clarity it is noted that on normal use conditions the first loudspeaker is positioned above the second loudspeaker. By positioning the second loudspeaker near a partition, such as a floor, diffuse sound can be created in those places where the frequencies of both loudspeakers cross each other. In this context it is to be noted that the term “diffuse sound” means in this paper the sound that arrives at a certain place not directly from the sound source, but after reflection.

The sound quality of the loudspeaker device according to the invention is improved in terms of definition, clarity and holographic imaging with respect to similar state of the art loudspeaker devices. For this reason the loudspeaker device according to the invention is suitable as a high fidelity device for audio reproduction as well as for TV, video and multi-media sound reinforcement. It offers a solution for current design and performance limitations related to multi-way loudspeaker devices and systems.

A preferred embodiment of the loudspeaker device according to the invention has the parameters 1000 Hz≦f_{c}≦2000 Hz and d≧3.λ_{fc}, particularly 1000 Hz≦f_{c}≦1500 Hz.

The lower-frequency range, i.e. the frequency range of the second loudspeaker, extends from a resonance frequency up to the crossover-frequency. The second loudspeaker may have a frequency range from 20 Hz to 10 kHz (typical 50 Hz-5 kHz). The higher frequency range, i.e. the frequency range of the first loudspeaker, extends upwardly from the crossover frequency. The first loudspeaker may have a frequency from 500 Hz to 100 kHz (typical 800 Hz-40 kHz).

Experiments have been done with a stereophonic arrangement having a pair of described second loudspeakers positioned close to the floor of a room and a pair of described first loudspeakers positioned at the required distance d above the second loudspeakers. Instead of the expected split-up of the reproduced stereo sound (music) image in a low-frequency content localized in a zone near the floor and a high-frequency content localized in a higher zone, it was surprisingly found that the stereo sound image was very stable positioned in the vertical plane just below (or near) the first loudspeakers, regardless of the frequency content of the reproduced sound. Most surprisingly was, moreover, the extremely high sound quality of the sound reproduction in terms of clarity, staging, homogeneity and transparency, and thus a true sensation of holographic stereo imaging was obtained. Specific parameters of the experiments are: a crossover frequency of 1 kHz; a vertical distance d between the pair of first loudspeakers and the pair of second loudspeakers of 1 m; and the use of first loudspeakers each having a dome-shaped membrane with an effective diameter of 30 mm.

For the sake of completeness it is here reported that the above-mentioned holographic capacity of the arrangement is completely lost if the first loudspeakers are mounted according to current principles, i.e. close to the second loudspeakers, but without changing the other parameters and with making use of the same filter and same components.

Similar effects, excepting the stereo image, have been obtained with a monophonic arrangement having the described second loudspeaker positioned close to the floor of a room and the described first loudspeaker positioned at the required distance d above the second loudspeaker.

A practical embodiment of the loudspeaker device according to the invention has the feature that the first radiation surface of the first loudspeaker has a circular outline and a diameter of 35 mm at the most. For reasons already mentioned above, the direct radiation surface is preferable a part of a dome-shaped membrane.

The invention further relates to a multiple loudspeaker housing. This housing is in principle based on the same recognition as described in the foregoing paragraphs, particularly the issue that the second loudspeaker(s) must be positioned with respect to the first loudspeaker(s) at such a distance that there is no or only minimal interference with the first loudspeaker(s).

The loudspeaker housing according to the invention comprises a set of a first loudspeaker for reproducing sound in a higher frequency range and a second loudspeaker for reproducing sound in a lower frequency range, the frequency ranges defining a crossover frequency f_{c}, which first loudspeaker is situated in a first place, preferably a front face, of the housing and has a first radiation surface of maximal 1000 mm², and which second loudspeaker is situated in a second face, not being the first face, of the housing and has a second radiation surface, a central area of the first radiation surface and a central area of the second radiation surface being situated, at least during use, at a vertical distance d with respect to each other, wherein

750 Hz≦f_{c}≦3000 Hz, preferably 1000 Hz≦f_{c}≦2000 Hz, particularly 1000 Hz f_{c}≦1500 Hz, and 150 mm≦d≦1000 mm.

Preferred embodiments of the multiple loudspeaker housing according to the invention and preferred parameters for implementation of this housing have been formulated and mentioned in the Claims 12 to 19. A particular, specific and surprising characterizing feature of the loudspeaker housing of the invention is that the first loudspeaker(s) is/are used for providing a direct sound field and the second loudspeaker(s) is/are used for providing a diffuse sound field, i.e. a field obtained after reflections.

The invention also relates to an audio and/or video apparatus provided with a loudspeaker arrangement formed by the stand-alone multiple loudspeaker device or the system according to the invention which includes the multiple loudspeaker housing according to the invention. The loudspeaker housing may be the housing of the apparatus itself or may be a kind of subhousing. As a result of the applied principle, as explained in the foregoing, the sound quality of the apparatus according to the invention is of a high-end level. In the context of this paper the video apparatus may be a monitor.

Furthermore, the invention relates to an audio and/or video apparatus as claimed in any one of the claims 21 to 27. Such an apparatus has the same benefits of the invention as aforesaid.

It is to be noted that the German Gebrauchsmuster No. 83 04 832 discloses a loudspeaker arrangement in a TV apparatus. This known arrangement comprises more than one loudspeaker in case of mono sound reproduction and more than two loudspeakers in case of stereo sound reproduction. Particularly, the known arrangement comprises a high-frequency loudspeaker and a low-frequency loudspeaker called subwoofer, and optionally comprises a middle-frequency loudspeaker. The high-frequency loudspeaker—and if present the middle-frequency loudspeaker—radiates from a front wall portion of the TV apparatus, while the subwoofer, which has a frequency range of 40 to 200 or 300 Hz, makes use of air openings to radiate from the rear side or bottom side of the TV apparatus. Thus, the known loudspeaker arrangement applied in the known TV apparatus has hardly any resemblance as to sound aspects with the loudspeaker arrangement applied in the apparatus according to the invention.

It is further to be noted that the German Gebrauchsmuster 16 87 888 discloses a loudspeaker box which is provided with a high-frequency sound system and low-frequency speaker or a broadband system. The high-frequency sound system is such designed and arranged that it radiates sound with frequencies of about 1.000 Hz or higher not only from a front side but also in other directions, such as backwards. For this reason the applied high-frequency sound system has the specific feature of having a plurality of radiation surfaces. By this feature, among others, the known loudspeaker box is essentially different from the loudspeaker structures according to the invention.

With reference to the Claims it is to be noted that various combinations of features as defined in the Claims are possible and intended within the scope of the invention.

The already above-mentioned and other objects, features and advantages of the present invention will become readily apparent from the following detailed exemplary description read in conjunction with the accompanying drawings, in which:

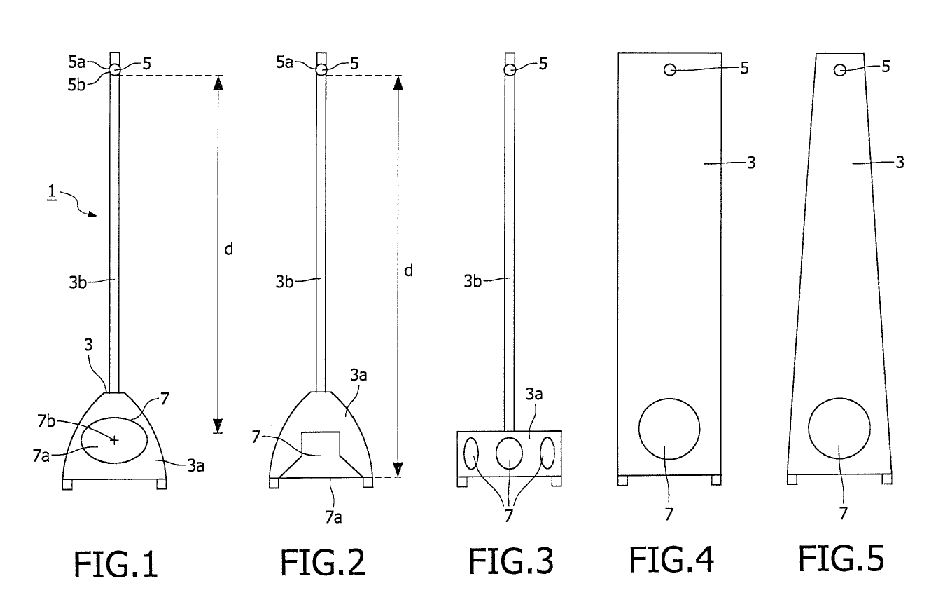

FIGS. 1 to 5 are schematic representations of embodiments of the multiple loudspeaker device according to the invention;

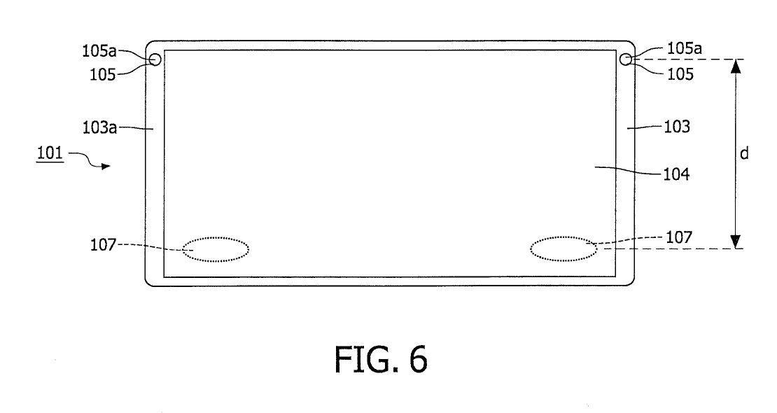

FIG. 6 is a schematic representation of an embodiment of the multiple loudspeaker housing according to the invention, applied in a TV-set;

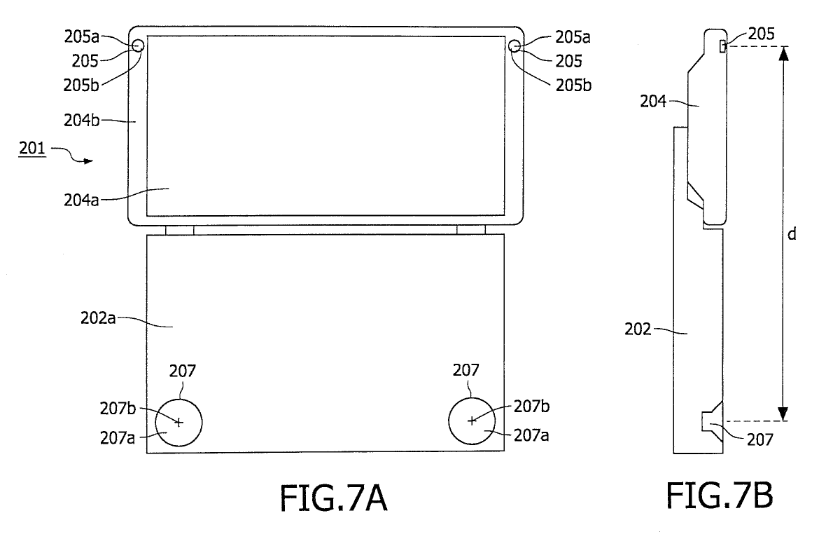

FIG. 7A is a schematic front view of an embodiment of the apparatus according to the invention; and

FIG. 7B is a schematic side view of the embodiment of FIG. 7A.

With reference now to FIG. 1, there can be seen a first embodiment of the multiple loudspeaker device 1 of the present invention. The device 1 has a frame 3 which comprises a base 3a and a stem, particularly a rod-like stem 3b. The base 3a is meant for resting upon a face, such as a floor and the like. An upper end of the stem 3b is provided with a first loudspeaker 5 having a first radiation surface 5a for reproducing sound in a higher frequency range, further also mentioned tweeter. A lower end of the stem 3b is secured to the base 3a. The base 3a is provided with a second loudspeaker 7 having a second radiation surface 7a for reproducing sound in a lower frequency range, further also mentioned woofer.

The tweeter 5 may be a conventionally available tweeter having a dome-shaped membrane, however with the additional condition that the diameter of its effective radiation surface is maximal 35 mm, preferably smaller. In this example the diameter of the effective radiation face is 30 mm. The crossover frequency f, of the speaker arrangement is 1.5 kHz. The frequency range of the tweeter 5 is 900 Hz to 30 kHz and the frequency range of the woofer 7 is 60 Hz to 5 kHz. The minimally required distance between the tweeter 5 and the woofer 7, i.e. the vertical distance d measured from a central area 5b to a central area 7b of the tweeter 5 and the woofer 7, respectively, is at least two times the wavelength λf, of the reproduced sound at the crossover frequency; or in another notation d≧2. λ_{fc}. In this example d is 900 mm.

As generally known, the wavelength λ_{fc} at the crossover frequency can be determined by the quotient of sound velocity in air (about 340 n/s) and the crossover frequency f_{c}; or in another notation

$${λ}_{fc} = \frac{∼ 340}{fc} ( in m ) .$$

In the present arrangement the vertical distance d is 1.1 m.

It is to be noted that the same reference signs will be used in the following description relating to the embodiments of the FIGS. 2 to 5 for parts corresponding to similar parts in the embodiment of FIG. 1.

The embodiment disclosed in FIG. 2 has a base 3a and a stem 3b provided with a foot 9 for resting on a face. The base 3a accommodates a woofer 7 with a radiation surface 7a positioned opposite said face. The stem 3b carries a tweeter 5 provided with a radiation surface 5a for radiating sound toward a listener being in front of the loudspeaker device.

The embodiment disclosed in FIG. 3 has a base 3a containing several woofers 7 and a stem 3b carrying a tweeter 5.

The embodiment disclosed in FIG. 4 has a support or frame 3 constituted by a rectangular box-like structure and housing a tweeter 5 and a woofer 7.

All the embodiments depicted in the FIGS. 1 to 5 have the parameters required to obtain the sound effects of the invention. More specifically, each of the tweeters 5 has a first radiation surface 5a of maximal 1000 mm²; and in all cases the distance d≧2.λ_{fc} and 750 mm≦d≦3000 mm, and 750 Hz≦f_{c}≦3000 Hz. To reproduce stereo sound, a set of two and if desired more of such multiple loudspeaker devices can be formed.

It is to be noted that the first loudspeaker and second loudspeaker may be units each constituted by two or more suitable speakers.

With reference now to FIG. 6, there can be seen an embodiment of the multiple loudspeaker housing 101 according to the invention. In this example the loudspeaker 101 is constituted by a television housing 103 of a TV set having in its front face 103a a screen 104. In this example the loudspeaker housing 101 comprises a loudspeaker set of two tweeters 105 and two woofers 107. The tweeters 105 have radiation surfaces 105a which are positioned in or near the front face 103a of the television housing 103, so that they are able to radiate sound from the front face 103a. Contrary thereto the woofers 207 are mounted such that their radiation surfaces 107a are positioned in or near a rear face of the television housing 103, so that they radiate sound during use from that face. The loudspeaker set as applied in the loudspeaker housing 101 fulfills the following additional requirements: (1) the radiation surfaces 105a of the tweeters 105 each have a size of maximal 1000 mm², (2) the crossover frequency f_{c} is lying in the range from 750 Hz to 3000 Hz and (3) the tweeters 105 on the one hand and the woofers 107 on the other hand are positioned at a vertical distance d in the ranges from 150 mm to 1000 mm. Preferably, the tweeters 105 are dome-shaped tweeters and 1000 Hz≦f_{c}≦1500 Hz. In this example is distance d is 350 mm.

With reference how to FIGS. 7A and 7B, there can be seen an embodiment of an apparatus 201 particularly a video apparatus, according to the invention. The apparatus 201 has a stand 202 and a flat screen television set 204 which is supported by the stand 202 and has a screen 204a. The television set 204 may be stationary or pivotally secured to the stand 202. The apparatus 201 is provided with a loudspeaker arrangement comprising two tweeters 205 and two woofers 207. The tweeters 205 are mounted at a high level in a frame part 207b of the television set 204 and the woofers 207 are mounted at a low level in a frame part 202a of the stand 202. Thus, the woofers 207 are positioned near a floor area. Both the radiation surfaces 205a of the tweeters 205 and the radiation surfaces 207a of the woofers 207 are located in or near a front face of the apparatus, i.e. the face substantially coinciding with the flat screen 204a. In order to obtain the effects aimed at by the invention the apparatus 201 has further the features that (1) the tweeters 205 have each a radiation surface 205a of maximal 1000 mm²; (2) the crossover frequency f_{c} has a value ≧750 Hz and ≦3000 Hz; and (3) central areas 205b of the tweeters 205 are situated at a vertical distance d from central areas 207b of the woofers 207, wherein the vertical value d is minimal 2.4, the term λ_{fc} being the wavelength of the reproduced sound at the crossover frequency and 750 mm≦d≦3000 mm.

In this embodiment the radiation surface is 490 mm², f_{c} is 1700 Hz and d is 1000 mm.

It is to be noted that the invention is not limited to the embodiments disclosed herein. For example a subwoofer may be additionally applied for reproducing only bass frequencies. The frequency range of such a subwoofer may be from the resonance frequency of the subwoofer to about 200 Hz.

What is claimed is:

1. A stand-alone multiple loudspeaker device comprising a frame with a first loudspeaker for reproducing sound in a higher frequency range and a second loudspeaker for reproducing sound in a lower frequency range, the frequency ranges having a crossover frequency f_{c}, which first loudspeaker has a first radiation surface of maximal 1000 mm² and which second loudspeaker has a second radiation surface, a central area of the first radiation surface and a central area of the second radiation surface being situated at a distance d, being a vertical distance, considered during use of the device, from each other, wherein
750 Hz≦f_{c}≦3000 Hz, and
d≧2.λ_{fc}, wherein λ_{fc} is the wavelength of the reproduced sound at the crossover frequency, and wherein d is minimal 750 mm and maximal 3000 mm.

2. A multiple loudspeaker device as claimed in claim 1, wherein 1000 Hz≦f_{c}≦2000 Hz, and d≧3.λ_{fc}.

3. A multiple loudspeaker device as claimed in claim 2, wherein 1000 Hz≦f_{c}≦1500 Hz.

4. A device as claimed in claim 1, wherein the lower frequency range extends from a resonance frequency up to the crossover frequency.

5. A device as claimed in claim 1, wherein the higher frequency range extends from the crossover frequency.

6. A device as claimed in claim 1, wherein the first radiation surface of the first loudspeaker has a circular outline and a diameter of 35 mm at the most.

7. A device as claimed in claim 1, wherein the second loudspeaker is situated underneath the first loudspeaker.

8. A device as claimed in claim 1, wherein the first radiation surface of the first loudspeaker is part of a dome-shaped membrane.

9. A device as claimed in claim 1, wherein only one first loudspeaker and only one second loudspeaker is present.

10. A stand-alone multiple loudspeaker system comprising at least two devices for stereo or stereo-like sound reproduction, each device having the following feature:
a frame with a first loudspeaker for reproducing sound in a higher frequency range and a second loudspeaker for reproducing sound in a lower frequency range, the frequency ranges having a crossover frequency f_{c}, which first loudspeaker has a first radiation surface of maximal 1000 mm² and which second loudspeaker has a second radiation surface, a central area of the first radiation surface and a central area of the second radiation surface being situated at a distance d, being a vertical distance, considered during use of the device, from each other, wherein
750 Hz≦f_{c}≦3000 Hz, and
d≧2.λ_{fc}, wherein λ_{fc} is the wavelength of the reproduced sound at the crossover frequency, and wherein d is minimal 750 mm and maximal 3000 mm.

11. A multiple loudspeaker housing comprising a set of a first loudspeaker for reproducing sound in a higher frequency range and a second loudspeaker for reproducing sound in a lower frequency range, the frequency ranges defining a crossover frequency f_{c}, which first loudspeaker is situated in a first face of the housing and has a first radiation surface of maximal 1000 mm², and which second loudspeaker is situated in a second face, not being the first face, of the housing and has a second radiation surface, a central area of the first radiation surface and a central area of the second radiation surface being situated, at least during use, at a vertical distance d with regard to each other, wherein 750 Hz≦f_{c}≦3000 Hz, wherein d is minimal 150 mm and maximal 1000 mm.

12. A multiple loudspeaker housing as claimed in claim 11, wherein 1000 Hz≦f_{c}≦2000 Hz.

13. A multiple loudspeaker housing as claimed in claim 12, wherein 1000 Hz≦f_{c}≦1500 Hz.

14. A housing as claimed in claim 11 wherein the lower frequency range extends from a resonance frequency up to the crossover frequency.

15. A housing as claimed in claim 11, wherein the higher frequency range extends from the crossover frequency.

16. A housing as claimed in claim 11, wherein the first radiation surface has a circular outline and a diameter of 35 mm at the most.

17. A housing as claimed in claim 11, wherein the second loudspeaker is mounted in a rear wall of the housing.

18. A housing as claimed in claim 11, wherein the first radiation surface of the first loudspeaker is part of a dome-shaped membrane.

19. A housing as claimed in claim 11, wherein only one first loudspeaker and only one second loudspeaker form the set.

20. A housing as claimed in claim 11, comprising a further similar set of loudspeakers for stereo or stereo-like sound reproduction.

21. An audio and/or video apparatus provided with a loudspeaker arrangement formed by the device as claimed in claim 1.

22. An audio and/or video apparatus provided with a multiple loudspeaker device comprising a first loudspeaker for reproducing sound in a higher frequency range and a second loudspeaker for reproducing sound in a lower frequency range, the frequency ranges having a crossover frequency f_{c}, which first loudspeaker has a first radiation surface of maximal 100 mm² and which second loudspeaker has a second radiation surface, a central area of the first radiation surface and a central area of the second radiation surface being situated at a distance d, being a vertical distance, considered during use of the device, from each other, wherein
750 Hz≦f_{c}≦3000 Hz, and
d≧2.λ_{fc}, wherein λ_{fc} is the wavelength of the reproduced sound at the crossover frequency, and wherein d is minimal 750 mm and maximal 3000 mm.

23. A multiple loudspeaker device as claimed in claim 22, wherein 1000 Hz≦f_{c}≦2000 Hz, and d≧3.λ_{fc}.

24. A multiple loudspeaker device as claimed in claim 23, wherein is 1000 Hz≦f_{c}≦1500 Hz.

25. A device as claimed in claim 22, wherein the lower frequency range extends from a resonance frequency up to crossover frequency.

26. A device as claimed in claim 22, wherein the higher frequency range extends from the crossover frequency.

27. A device as claimed in claim 22, wherein the first radiation surface of the first loudspeaker has a circular outline and a diameter of 35 mm at the most.

28. A device as claimed in claim 22, wherein the second loudspeaker is situated underneath the first loudspeaker.
